(19) United States
(12) Patent Application Publication
(10) Pub. No.: US 2017/0088197 A1
(43) Pub. Date: Mar. 30, 2017

(54) METHOD OF USING PRESSURE SENSORS TO DIAGNOSE ACTIVE AERODYNAMIC SYSTEM AND VERIFY AERODYNAMIC FORCE ESTIMATION FOR A VEHICLE

(71) Applicant: GM GLOBAL TECHNOLOGY OPERATIONS LLC, Detroit, MI (US)

(72) Inventor: Edward T. Heil, Howell, MI (US)

(73) Assignee: GM GLOBAL TECHNOLOGY OPERATIONS LLC, Detroit, MI (US)

(21) Appl. No.: 15/252,881

(22) Filed: Aug. 31, 2016

Related U.S. Application Data
(60) Provisional application No. 62/232,801, filed on Sep. 25, 2015.

(51) Int. Cl. B62D 35/00; G01M 9/00; B62D 35/02

(52) U.S. Cl. CPC B62D 35/005; B62D 35/02; G01M 9/00

(57) ABSTRACT

A method of controlling a vehicle having an active aerodynamic feature includes sensing a static pressure adjacent to the active aerodynamic feature. An estimated aero force from measured pressure is calculated from the sensed static pressure adjacent the aerodynamic feature. The estimated aero force from measured pressure is compared to an estimated aero force from current vehicle operating conditions, to determine a deviation therebetween. A control signal including the deviation is sent to a vehicle control system, so that the vehicle control system may control a system of the vehicle based on the deviation.

### CROSS-REFERENCE TO RELATED APPLICATIONS

This application claims the benefit of U.S. Provisional Patent Application Ser. No. 62/232,801, filed on Sep. 25, 2015, the disclosure of which is hereby incorporated by reference.

### TECHNICAL FIELD

The disclosure generally relates to a method of controlling a vehicle having an active aerodynamic feature, which is movable to change an aerodynamic force.

### BACKGROUND

Vehicle design related to aerodynamics includes factors affecting vehicle drag and downforces, which affect vehicle traction, cornering and other elements of vehicle stability. As understood by those skilled in the art, vehicle drag forces include aerodynamic friction and/or flow resistance forces that act in a direction opposite a direction of travel of the vehicle, and vehicle downforces include lift forces acting on the vehicle in a downward, normal direction relative to a direction of travel of the vehicle. Aerodynamic design elements may include passive aerodynamic features and/or active aerodynamic features. Passive aerodynamic features are fixed in position and do not move. Active aerodynamic features are moveable and re-positionable to change or control an aerodynamic force, such as an aerodynamic drag force or an aerodynamic downforce that acts on the vehicle. Vehicles may include multiple aerodynamic features, active and/or passive, located at different locations on the vehicle.

### SUMMARY

A method of controlling a vehicle having an active aerodynamic feature is provided. The method includes sensing a static pressure adjacent to the active aerodynamic feature. An aerodynamic force acting on the vehicle at the active aerodynamic feature is calculated with the diagnostic controller, from the sensed static pressure adjacent the aerodynamic feature. The calculated aerodynamic force is defined as an estimated aero force from measured pressure. The diagnostic controller compares the estimated aero force from measured pressure to an estimated aero force from current vehicle operating conditions, to determine a deviation between the estimated aero force from measured pressure and the estimated aero force from current vehicle operating conditions. The diagnostic controller sends a control signal, which includes the deviation, to a vehicle control system, so that the vehicle control system may control a system of the vehicle based on the deviation between the estimated aero force from measured pressure and the estimated aero force from current vehicle operating conditions.

The estimated aero force from current vehicle operating conditions is the aerodynamic force that an aerodynamic controller of the vehicle estimates should be generated by the active aerodynamic feature for the current operating conditions of the vehicle. Comparing the aerodynamic force acting on the vehicle at the active aerodynamic feature that is calculated from the measured static pressure to the estimated aero force from current vehicle operating conditions provides a diagnostic check to verify the value of the estimated aero force from current vehicle operating conditions. This diagnostic comparison may determine that the value of the estimated aero force from current vehicle operating conditions is valid, and the vehicle may be controlled based on this value, or is not-valid, and the vehicle should not be controlled based on this value.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a vehicle showing an active aerodynamic feature.

FIG. 2 is an enlarged schematic side view of the vehicle showing the active aerodynamic feature, and an alternative sensor location.

FIG. 3 is a flowchart representing a method of controlling the vehicle.

FIG. 4 is an enlarged schematic side view of the vehicle showing the active aerodynamic feature and an alternative sensor location.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

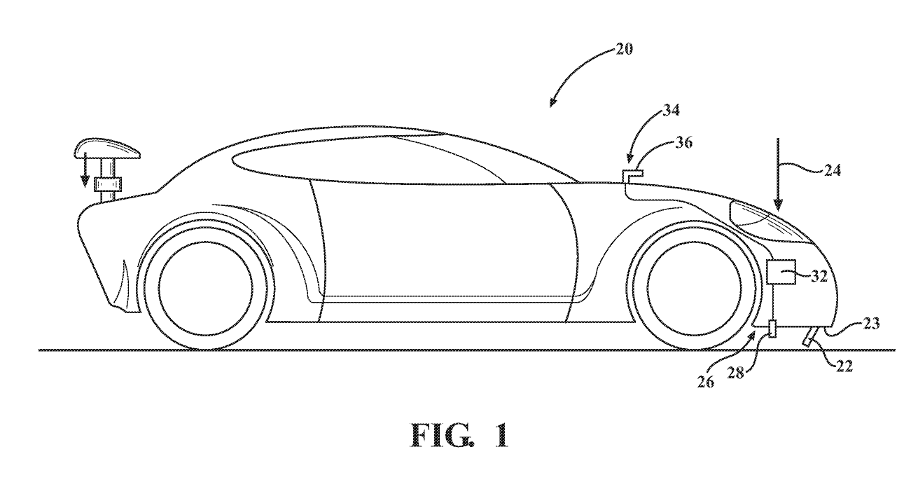

Referring to the Figures, wherein like numerals indicate like parts throughout the several views, a vehicle is generally shown at 20 in FIG. 1. Referring to FIG. 1, the vehicle 20 may include any style and/or configuration of vehicle 20, and includes at least one active aerodynamic feature 22. The active aerodynamic feature 22 is attached to an exterior body surface 23 of the vehicle 20, and is controllable to move between different positions to affect an aerodynamic force 24 on the vehicle 20. As shown in FIG. 1, the active aerodynamic feature 22 includes and is shown as a Gurney Flap disposed adjacent a lower forward end of the vehicle 20. However, it should be appreciated that the active aerodynamic feature 22 may be embodied as some other device at some other location on the vehicle 20, such as but not limited to a front or rear spoiler for example. The active aerodynamic feature 22 is operable to generate values of an aerodynamic drag force and/or an aerodynamic downforce, referred to generally as the aerodynamic force 24. The active aerodynamic feature 22 may be configured in any manner, and located at any location of the vehicle 20, that enables the active aerodynamic feature 22 to generate the aerodynamic force 24 that acts on the vehicle 20.

As used herein, the term “aerodynamic drag force” is defined as a force acting on the vehicle 20 in a direction opposite the direction of travel of the vehicle 20, to oppose movement of the vehicle 20. As used herein, the term “aerodynamic downforce” is defined as a lift force acting on the vehicle 20 in a downward, normal direction relative to a direction of travel of the vehicle 20. The aerodynamic force 24 shown in the exemplary embodiment of FIG. 1 is depicted as an aerodynamic downforce.

The aerodynamic feature may include one or more actuators (not shown) that move the aerodynamic feature between one or more different positions. Each position of the aerodynamic feature provides varying amounts of aerodynamic force 24, i.e., either the aerodynamic drag force and/or the aerodynamic downforce. The specific construction and operation of the aerodynamic feature is not pertinent to the teachings of this disclosure, and is therefore not described in detail herein.

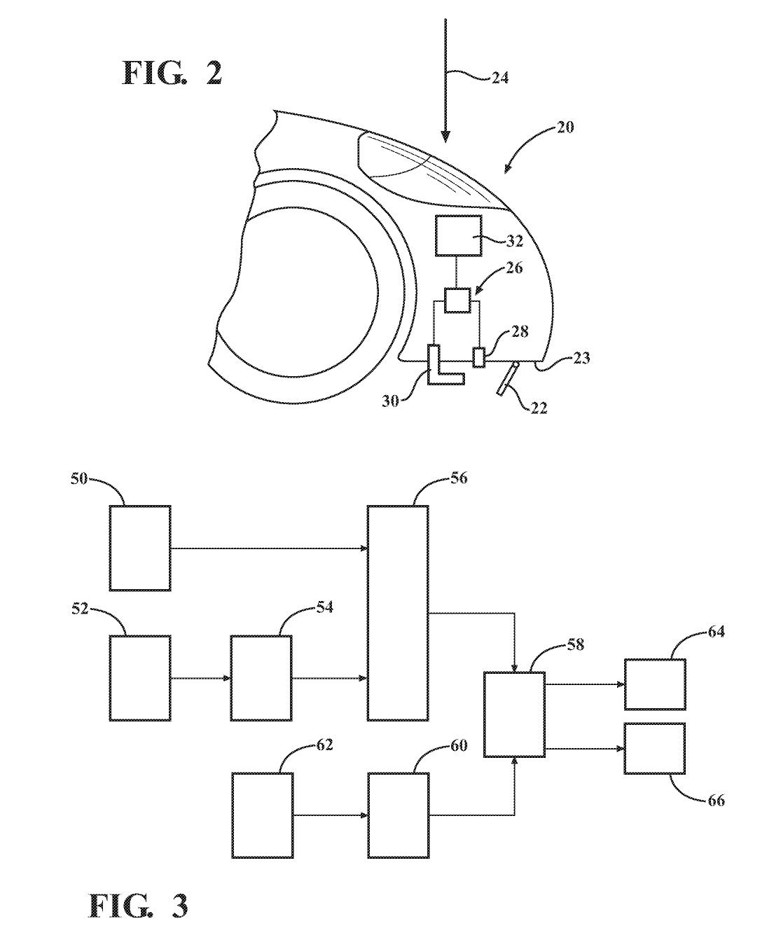

Referring to FIGS. 1 and 2, the vehicle 20 includes a first pressure sensing system 26 disposed immediately adjacent and rearward of the active aerodynamic feature 22. Although the first pressure sensing system 26 is shown immediately rearward of the active aerodynamic feature 22, it should be appreciated that the first pressure sensing system 26 may be located forward of the active aerodynamic feature 22. As used herein to describe the location of the first pressure sensing system 26, the term “adjacent” should be interpreted as being located within a distance in which air flow is affected, and “not adjacent” should be interpreted as being located in a position in which air flow is not affected. In some embodiments, having the first pressure sensing system 26 located forward of the active aerodynamic feature 22 may provide the best measurement for calculating the aerodynamic forces generated by the active aerodynamic feature 22. As shown in the Figures, the first pressure sensing system 26 is positioned to measure the static air pressure and/or the total air pressure after the air pressure of the flow of air across the active aerodynamic feature 22 has been effected by the active aerodynamic feature 22. The static air pressure and/or the total air pressure sensed by the first pressure sensing system 26 adjacent the active aerodynamic feature 22 is used to calculate an air velocity at the active aerodynamic feature 22, described in greater detail below.

The first pressure sensing system 26 may include any sensor capable of sensing at least a static air pressure. Additionally, the first pressure sensing system 26 may include a sensor that is also capable of sensing a total air pressure. As is known, the total air pressure is sometimes referred to as the stagnation air pressure or the pitot air pressure. The first pressure sensing system 26 may include, but is not limited to, a pitot-static pressure sensor 28 that is capable of simultaneously sensing both the total air pressure and the static air pressure with a single probe, such as shown in FIG. 1. Alternatively, and as best shown in FIG. 2, the first pressure sensing system 26 may include a static pressure sensor 28 for sensing the static air pressure, and a pitot pressure sensor 30 for sensing the total air pressure. The first pressure sensing system 26 is in communication with a diagnostic controller 32, and communicates the sensed data related to the static pressure and the total pressure adjacent the active aerodynamic feature 22 to the diagnostic controller 32 to enable the operations of the diagnostic controller 32 described in greater detail below.

The vehicle 20 may further include a second pressure sensing system 34. As shown in FIG. 1, the second pressure sensing system 34 is positioned on an upper surface of the vehicle 20, such as on a roof or on top of a hood of the vehicle 20, and is operable to sense at least one of a total air pressure and/or a static air pressure adjacent the upper surface of the vehicle 20. However, the location of the second pressure sensing system may vary, and may include a second location on the vehicle that is not adjacent to the active aerodynamic feature 22, and is not located on upper surface of the vehicle. As used herein to describe the location of the second pressure sensing system, the term “adjacent” should be interpreted as being located within a distance in which air flow is affected by the active aerodynamic feature 22, and “not adjacent” should be interpreted as being located in a position in which air flow is not affected by the active aerodynamic feature 22. The location of the second pressure sensing system 34 may vary depending on the configuration and location of the active aerodynamic feature 22. For example, referring to FIG. 4, the second pressure sensing system 34 is shown located forward of the active aerodynamic feature 22, and on a lower surface of the vehicle 20. The total air pressure and/or the static air pressure sensed from the second pressure sensing system 34 may be used to calculate an airspeed of the vehicle 20, described in greater detail below.

The second pressure sensing system 34 may include any sensor capable of sensing a static air pressure and/or a total air pressure. As shown in FIG. 1, the second pressure sensing system 34 may include, but is not limited to, a pitot-static pressure sensor 36 that is capable of simultaneously sensing both the total air pressure and the static air pressure with a single probe. Alternatively, the second pressure sensing system 34 may include a static pressure sensor for sensing the static air pressure, and/or a pitot pressure sensor for sensing the total air pressure. Referring to FIG. 4, the second pressure sensing system 34 is shown including a static pressure sensor 35 located forward of the active aerodynamic feature 22, in combination with the static pressure sensor 28 of the first pressure sensing system 26 located rearward of the active aerodynamic feature 22. The second pressure sensing system 34 is in communication with the diagnostic controller 32, and communicates the sensed data related to the static pressure and/or the total pressure at the location of the second pressure sensing system 34 to the diagnostic controller 32 to enable the operation of the diagnostic controller 32 described in greater detail below.

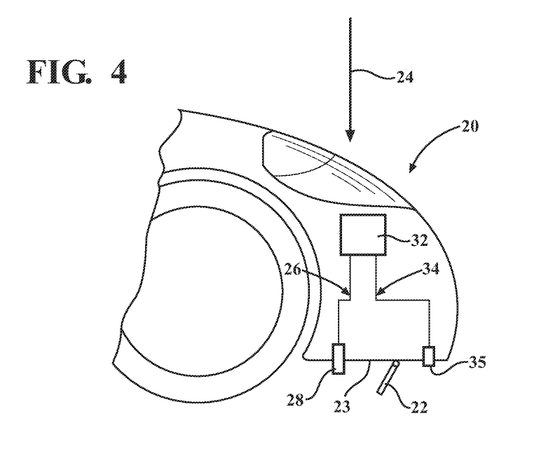

The actuators of the aerodynamic feature, and thereby the position of the aerodynamic feature, are controlled by a vehicle controller. The vehicle controller may be referred to generally as, but not limited to a vehicle 20 control unit, a module or vehicle 20 control module, a computer, or other similar device. The vehicle controller may be referred to herein as the diagnostic controller 32. The vehicle controller controls the operation of the active aerodynamic feature 22. The vehicle controller may include a computer and/or processor, and include all software, hardware, memory, algorithms, connections, sensors, etc., necessary to manage and control the operation of the active aerodynamic feature 22. As such, a method, described below and generally shown in FIG. 3, may be embodied as a program or algorithm operable on the vehicle controller. It should be appreciated that the vehicle controller may include any device capable of analyzing data from various sensors, comparing data, making the necessary decisions required to control the operation of the aerodynamic feature, and executing the required tasks necessary to control the operation of the aerodynamic feature.

The vehicle controller may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The vehicle controller includes tangible, non-transitory memory on which are recorded computer-executable instructions, including an aerodynamic diagnostic algorithm. The processor of the vehicle controller is configured for executing the aerodynamic diagnostic algorithm, which implements a method of controlling the vehicle 20, and more specifically a method of controlling the active aerodynamic feature 22.

Referring to FIG. 3, the method of controlling the aerodynamic feature of the vehicle 20 includes sensing a speed of the vehicle 20, generally indicated by box 50. The speed of the vehicle 20 may be sensed in any suitable manner, and may include a ground speed of the vehicle 20 or an air speed of the vehicle 20. If the ground speed of the vehicle 20 is used in the process described below, then the speed of the vehicle 20 may be sensed by sensing a rotational speed of at least one drivetrain component with a rotational speed sensor. For example, a rotational speed of a wheel may be sensed with a wheel speed sensor. The data from the wheel speed sensor may be communicated to the diagnostic controller 32, either directly or through some other vehicle controller, to provide the diagnostic controller 32 with the ground speed of the vehicle 20.

However, a more precise measurement of the speed of the vehicle 20 for the process described below is the relative airspeed of the vehicle 20, which takes into account both the ground speed of the vehicle 20 and the wind speed relative to the vehicle 20. In order to sense the air speed of the vehicle 20, i.e., the flow velocity of the air relative to the vehicle 20, the vehicle 20 may be equipped with the second pressure sensing system 34 described above, and may be positioned on an upper surface of the vehicle 20, such as a roof or hood of the vehicle 20. In order to calculate the flow velocity of the air relative to the vehicle 20, the second pressure sensing system 34 senses a dynamic pressure at an upper surface of the vehicle 20, and uses the dynamic pressure at the upper surface of the vehicle 20 to calculate the flow velocity of the air relative to the vehicle 20. In order to sense the dynamic pressure at the upper surface of the vehicle 20, the second pressure sensing system 34 senses a total pressure at the upper surface of the vehicle 20, and a static pressure at the upper surface of the vehicle 20. The static pressure is subtracted from the total pressure to define the dynamic pressure at the upper surface of the vehicle 20. Calculating the airspeed at the upper surface of the vehicle 20 may include, for example, solving the Equation 1 for the flow velocity of the air. Equation 1 calculates the flow velocity of a fluid, assuming incompressible flow.

$$u = \sqrt{\frac{2 ( {P}_{t} - {P}_{s} )}{ρ}} \qquad 1 )$$

Referring to Equation 1 above, u is the flow velocity of the air (i.e., the calculated air speed), Pₜ is the total air pressure (often referred to as the stagnation air pressure), Pₛ is static air pressure, and ρ is the fluid density in Kg/m³.

Alternatively, the airspeed adjacent the active aerodynamic feature may be calculated from Equation 2 below, which calculates the calibrated air speed.

$${V}_{c} = {A}_{0} \sqrt{5 [ {( \frac{{q}_{c}}{{P}_{0 }} + 1 )}^{\frac{2}{7}} - 1 ]} \qquad 2 )$$

Referring to Equation 2 above, V_{c} is the calibrated air speed, A₀ is the dynamic pressure, P₀ is static air pressure at standard sea level (29.92126 inches Hg), and q_{c} is speed of sound at standard sea level (661.4788 knots).

In addition to sensing either the ground speed or the airspeed of the vehicle 20, the method includes sensing a dynamic pressure adjacent to the active aerodynamic feature 22, generally indicated by box 52, with the first pressure sensing system 26 described above.

The diagnostic controller 32 uses the dynamic pressure adjacent to the active aerodynamic feature 22 to calculate the airspeed adjacent the active aerodynamic feature 22, generally indicated by box 54. In order to sense the dynamic pressure adjacent the active aerodynamic feature 22, the first pressure sensing system 26 senses a total pressure with a pitot pressure sensor 30 positioned immediately adjacent to the active aerodynamic feature 22. Additionally, the first pressure sensing system 26 senses a static pressure with a static pressure sensor 28 positioned immediately adjacent to the active aerodynamic feature 22.

The static pressure is subtracted from the total pressure to define the dynamic pressure adjacent the active aerodynamic feature 22. Calculating the airspeed adjacent the active aerodynamic feature 22 may include, for example, solving the Equation 1 for the flow velocity of the air adjacent the active aerodynamic feature 22. In order to further enhance the accuracy of this calculation, it may be necessary to sense the ambient temperature and the ambient atmospheric pressure, and use these values to calculate the density of the air for use in Equation 1.

The diagnostic controller 32 calculates an aerodynamic force 24 acting on the vehicle 20 at the active aerodynamic feature 22, generally indicated by box 56, from the sensed speed of the vehicle 20 and the sensed airspeed adjacent the aerodynamic feature. The value of the aerodynamic force 24 acting on the vehicle 20 at the active aerodynamic feature 22 is defined in the memory of the diagnostic controller 32 and referred to hereinafter as the “estimated aero force from measured pressure”. The estimated aero force from measured pressure may include an aerodynamic downforce and/or an aerodynamic drag force, as described above, depending upon the specific configuration of the active aerodynamic feature 22. The estimated aero force from measured pressure represents a measured value of the aerodynamic force 24 being applied to the vehicle 20 by the aerodynamic feature.

In order to calculate or define the estimated aero force from measured pressure, the diagnostic controller 32 inputs the sensed speed of the vehicle 20 and the calculated airspeed adjacent the active aerodynamic feature 22 into a computer model, which outputs the estimated aero force from measured pressure. The computer model used to output the estimated aero force from measured pressure may be based and/or derived from wind tunnel testing and/or computerized fluid dynamics calculations. Furthermore, the computer model used to output the estimated aero force from measured pressure may include one or more look-up tables stored in the memory of the diagnostic controller 32, and used to relate the values of the speed of the vehicle 20 and the air speed adjacent the active aerodynamic feature 22 to the estimated aero force from measured pressure.

If the vehicle 20 is equipped with the second pressure sensing system 34 that is capable of sensing the static pressure at a location not adjacent the active aerodynamic feature, such as but not limited to an upper surface of the body of the vehicle 20, then the estimated aero force from measured pressure may be calculated in an alternative method than described above. The alternative method of calculating the estimated aero force from measured pressure includes sensing the static pressure adjacent to the active aerodynamic feature 22, such as described above, and sensing the static pressure adjacent a second location on the body of the vehicle 20, away from the active aerodynamic feature 22, such as but not limited to an upper surface of the body of the vehicle 20. The diagnostic controller 32 may input the static pressure adjacent the active aerodynamic feature 22 and the static pressure at the second location on the body into a computer model, which outputs the estimated aero force from measured pressure. The computer model used to output the estimated aero force from measured pressure may be based and/or derived from wind tunnel testing and/or computerized fluid dynamics calculations. Furthermore, the computer model used to output the estimated aero force from measured pressure may include one or more look-up tables stored in the memory of the diagnostic controller 32, and used to relate the values of the static pressure adjacent to the active aerodynamic feature and the static pressure adjacent the second location on the body to the estimated aero force from measured pressure.

Furthermore, instead of using two different pressure sensing systems, i.e., the first pressure sensing system 26 and the second pressure sensing system 34, the vehicle may be equipped with only a single, pressure differential system that is capable of measuring a difference in pressure between two different locations on the body of the vehicle 20, i.e., in the first location adjacent the active aerodynamic feature 22, and the second location not adjacent to the active aerodynamic feature 22, such as but not limited to an upper surface of the vehicle 20.

Once the diagnostic controller 32 has defined or calculated the estimated aero force from measured pressure, the diagnostic controller 32 compares the estimated aero force from measured pressure to an “estimated aero force from current vehicle operating conditions”, generally indicated by box 58. The estimated aero force from current vehicle operating conditions is the aerodynamic force 24 that an aerodynamic controller of the vehicle 20 estimates should be generated by the active aerodynamic feature 22 for the current operating conditions of the vehicle 20, and is used by other control systems of the vehicle 20 to control different aspects of the vehicle 20. The estimated aero force from current vehicle operating conditions may be determined and/or defined in any suitable manner. Determination of the estimated aero force from current vehicle operating conditions is generally indicated by box 60. For example, an aerodynamic control system may include a model or look-up table that uses a plurality of different vehicle 20 operating conditions as inputs, generally indicated by box 62, and outputs the estimated aero force from current vehicle operating conditions. The current operating conditions that may be considered in defining the estimated aero force from current vehicle operating conditions may include, but are not limited to, a current position of the active aerodynamic feature 22, a velocity of the vehicle 20, an estimated ride height of the vehicle 20, air density, vehicle 20 roll, vehicle 20 pitch, vehicle 20 heading angle, vehicle 20 acceleration, etc. An example of an aerodynamic control system that is capable of determining the estimated ride height of the vehicle is described in U.S. Provisional Patent Application Ser. No. 62/220,010, filed on Sep. 17, 2015, herein incorporated by reference, and assigned to the Assignee of this application.

The diagnostic controller 32 compares the estimated aero force from measured pressure to the estimated aero force from current vehicle operating conditions to determine a deviation therebetween. As noted above, the estimated aero force from current vehicle operating conditions is the defined value that the vehicle 20 control systems use to control the different systems of the vehicle 20, whereas the estimated aero force from measured pressure is derived from measured forces currently acting on the vehicle 20. The estimated aero force from measured pressure is used within the process described herein as a diagnostic check on the estimated aero force from current vehicle operating conditions to determine if the estimated aero force from current vehicle operating conditions is a valid estimate of the aerodynamic force 24 being applied to the vehicle 20 at the active aerodynamic feature 22.

Once the diagnostic controller 32 has calculated the deviation between the estimated aero force from measured pressure to the estimated aero force from current vehicle operating conditions, the diagnostic controller 32 may send a control signal, including the deviation and generally indicated by box 64, to another vehicle 20 control system, so that the other vehicle 20 control system may control a respective system of the vehicle 20 based on the deviation between the estimated aero force from measured pressure and the estimated aero force from current vehicle operating conditions.

Additionally, the diagnostic controller 32 may define a force estimate diagnostic flag, generally indicated by box 66. The force estimate flag is a computer logic flag indicating whether the diagnostic controller 32 has determined if the estimated aero force from current vehicle operating conditions is or is not a valid estimate of the aerodynamic force 24 acting on the vehicle 20 at the active aerodynamic feature 22. The diagnostic controller 32 may pass the force estimate diagnostic flag onto the other vehicle 20 control systems so that they may control their respective vehicle 20 systems more accurately. The force estimate diagnostic flag may be defined as valid when the deviation is equal to or less than a maximum allowable value. The force estimate diagnostic flag may be defined as non-valid when the deviation is greater than the maximum allowable value. The maximum allowable value may be defined based on the specific vehicle 20 performance characteristics, or some other criteria, and represents an allowable range for the estimated aero force from current vehicle operating conditions.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of controlling a vehicle having an active aerodynamic feature, the method comprising:
sensing a static pressure adjacent to the active aerodynamic feature;
calculating an aerodynamic force acting on the vehicle at the active aerodynamic feature from the sensed static pressure adjacent the aerodynamic feature, and defining the calculated aerodynamic force as an estimated aero force from measured pressure;
determining an estimated aero force from current vehicle operating conditions;
comparing the estimated aero force from measured pressure to the estimated aero force from current vehicle operating conditions to determine a deviation between the estimated aero force from measured pressure and the estimated aero force from current vehicle operating conditions; and
sending a control signal, including the deviation, to a vehicle control system so that the vehicle control system may control a system of the vehicle based on the deviation between the estimated aero force from measured pressure and the estimated aero force from current vehicle operating conditions.

2. The method set forth in claim 1 further comprising sensing a total pressure adjacent to the active aerodynamic feature.

3. The method set forth in claim 2 further comprising calculating a flow velocity of the air adjacent to the active aerodynamic feature using the sensed static pressure adjacent to the active aerodynamic feature and the sensed total pressure adjacent to the active aerodynamic feature

4. The method set forth in claim 3 wherein calculating the flow velocity of the air adjacent the active aerodynamic feature includes calculating the dynamic pressure by subtracting the static pressure from the total pressure.

5. The method set forth in claim 4 wherein calculating the flow velocity of the air adjacent the active aerodynamic feature includes calculating the flow velocity of the air relative to the vehicle from the equation:
$$u = \sqrt{\frac{2 ( {P}_{t} - {P}_{s} )}{ρ}}$$
wherein u is the flow velocity of the air, Pₜ is the total air pressure, Pₛ is static air pressure, and ρ is the fluid density of the air in Kg/m³.

6. The method set forth in claim 5 further comprising sensing an ambient temperature and an ambient atmospheric pressure.

7. The method set forth in claim 6 further comprising using the ambient temperature and the ambient atmospheric pressure to calculate the fluid density of the air.

8. The method set forth in claim 5 further comprising sensing a speed of the vehicle.

9. The method set forth in claim 8 wherein calculating the aerodynamic force acting on the vehicle at the active aerodynamic feature from the sensed static pressure adjacent the aerodynamic feature includes inputting the sensed speed of the vehicle and the calculated flow velocity of air adjacent the aerodynamic feature into a computer model that outputs the estimated aero force from measured pressure.

10. The method set forth in claim 1 wherein determining the estimated aero force from current vehicle operating conditions comprises inputting a plurality of different vehicle operating conditions into a model that outputs the estimated aero force from current vehicle operating conditions.

11. The method set forth in claim 1 further comprising defining a force estimate diagnostic flag, wherein the force estimate diagnostic flag is defined as valid when the deviation is equal to or less than a maximum allowable value, and wherein the force estimate diagnostic flag is defined as non-valid when the deviation is greater than the maximum allowable value.

12. The method set forth in claim 11 further comprising sending a control signal, including the force estimate diagnostic flag, to a vehicle control system having a diagnostic controller, so that the vehicle control system may control a system of the vehicle based on the estimated aero force from current vehicle operating conditions.

13. The method set forth in claim 8 wherein sensing a speed of the vehicle includes sensing a rotational speed of at least one drivetrain component of the vehicle with a rotational speed sensor.

14. The method set forth in claim 8 wherein sensing a speed of the vehicle includes sensing a dynamic pressure at a second location on the vehicle that is not adjacent to the active aerodynamic feature, with a pitot-static pressure sensor and calculating a vehicle airspeed from the sensed dynamic pressure at the second location on the vehicle.

15. The method set forth in claim 1 further comprising sensing a static pressure adjacent a second location on the vehicle that is not adjacent to the active aerodynamic feature.

16. The method set forth in claim 15 wherein calculating an aerodynamic force acting on the vehicle at the active aerodynamic feature from the sensed static pressure adjacent the aerodynamic feature includes inputting the sensed static pressure adjacent the aerodynamic feature and the sensed static pressure adjacent the second location on the vehicle into a computer model that outputs the aerodynamic force acting on the vehicle.

17. A vehicle comprising:
a body defining an exterior body surface;
an active aerodynamic feature attached to the exterior surface of the body and moveable between at least two different positions for generating a variable amount of an aerodynamic force that is applied to the body; and
a first pressure sensing system disposed adjacent to the active aerodynamic future and operable to sense a static pressure immediately adjacent to the active aerodynamic feature.

18. The vehicle set forth in claim 17 wherein the first pressure sensing system includes a pitot-static pressure sensor operable to sense a total pressure and a static pressure.

19. The vehicle set forth in claim 18 further comprising a diagnostic controller in communication with the first pressure sensing system and operable to calculate an air speed from the static pressure and the total pressure sensed by the first pressure sensing system.

20. The vehicle set forth in claim 17 further comprising:
a second pressure sensing system disposed adjacent a second location on the vehicle, and operable to sense a static pressure adjacent the second location on the vehicle;
a diagnostic controller in communication with the first pressure sensing system and the second pressure sensing system and operable to calculate an estimated aerodynamic force from measured pressure acting on the vehicle at the active aerodynamic feature, from the sensed static pressure adjacent the active aerodynamic feature and the sensed static pressure adjacent the second location on the vehicle.
